(19) United States
(12) Patent Application Publication
(10) Pub. No.: US 2007/0051752 A1
(43) Pub. Date: Mar. 8, 2007

(54) Device providing quick and simple attainable disinfection or sanitary action when required

(76) Inventor: Jan Gunnar Lapins, Stockholm (SE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 10/566,771

(22) PCT Filed: Jul. 30, 2004
(86) PCT No.: PCT/SE04/01156

§ 371 Date: Aug. 30, 2006

(30) Foreign Application Priority Data
Jul. 31, 2003 (SE) 0302153-2

(51) Int. Cl. B67D 5/64; B43M 11/06

(52) U.S. Cl. 222/168; 401/207

(57) ABSTRACT

The invention refers to a device enabling sanitation of the hands of at least one person and including a container comprising the sanitary substance. Further, there is a valve making possible repeatedly distributing via an outlet of said sanitary substance. The purpose of the device is making possible sanitation of, primarily, said hands of said person at a proper moment independent of factual location of said person. The device is characterized in that said valve comprises an openable closing valve 2, 12. Said openable closing valve 2 and said outlet 3a are facing away from said person and are reachable with at least one hand of said person. Said container 1 comprising sanitary substance is pressurized, exposed to or by gravitation, or in any other way influenced to, in a single motion and immediately, distribute desired and depending on manual action time of said openable closing valve 2 amount of sanitary substance via said outlet 3a, as soon as said openable closing valve 2 is opened Said container 1 is designed to collapse essentially without letting in air to the inner of the container, when emptying said container.

The invention relates to a device enabling sanitation of the hands of at least one person and including a container comprising a sanitary substance and a valve making possible repeatedly distributing via an outlet from said container of the amount of said sanitary substance desired.

The distribution of pollutions and infections in the society and especially within the health care sector are a widely spread, severely and growing problem.

The most common source of such distribution of pollutions and/or infections is via polluted or contaminated hands and is based upon lack of adequate sanitation.

Despite the knowledge of appropriate sanitation hygiene and/or disinfection of the hands as a preventive measure is since long ago established and despite there are good intentions and high ambitions to master such preventive actions correctly, several studies show that the hand hygiene does not work as intended, primarily, under stressed circumstances, the performance of sanitation of the hands do become so impracticable to perform and is hereby not performed in reality.

Currently, stationary devices are used primarily for managing disinfection or in relevant cases sanitation. Such stationary devices are almost without exception located close to stationary installed basins for cleaning hands and are only in exceptional cases located at the beds of the patients.

Such known devices require that the person has to relocate from the present location to the nearest stationary basin for sanitation, sterilisation or disinfection of the hands and with repeated demands for sanitation, repeated relocations increase the exposure of contaminations and the risk of catching infectious matters increases as well.

A smaller bottle designed to be carried, for example, in a pocket of a shirt or in a toolbox is previously known and increases the possibility for disinfection by being close at hand.

A primary disadvantage of said known bottle is that it has to be gripped and lifted out of the pocket or out of the toolbox with one hand, be turned upside down and then be opened by the other hand in order to squeeze out an appropriate amount of agent from the bottle on to the hands and thereafter reclose it and put it back into the pocket or into the toolbox. Such a handling contaminates the bottle with all possible germs the hands had before sanitising and the bottle should be sanitised each time it has been used before it is put back into the pocket or into the toolbox. Such an action is neither practicable nor feasible in reality. This is even less likely to be done repeatedly, during a limited time of duration and/or under time strain. The bottle will, for instance, contaminate the garment storage space, if not decontaminated. In other words, a single bottle in a pocket or in a toolbox does not constitute an acceptable solution to the problem of dissemination of contagions.

Concerning state of the art, according to, among others, U.S. Pat. No. 5,683,012 the following should be noticed.

Medical staff is normally obliged to avoid carrying accessories like belts outermost. Likewise, medical staffs do rarely have the waistband of the pants outermost, as both belts and waistbands of the pants act as a collector of contaminants and belts are, furthermore, difficult to cleanse when washed.

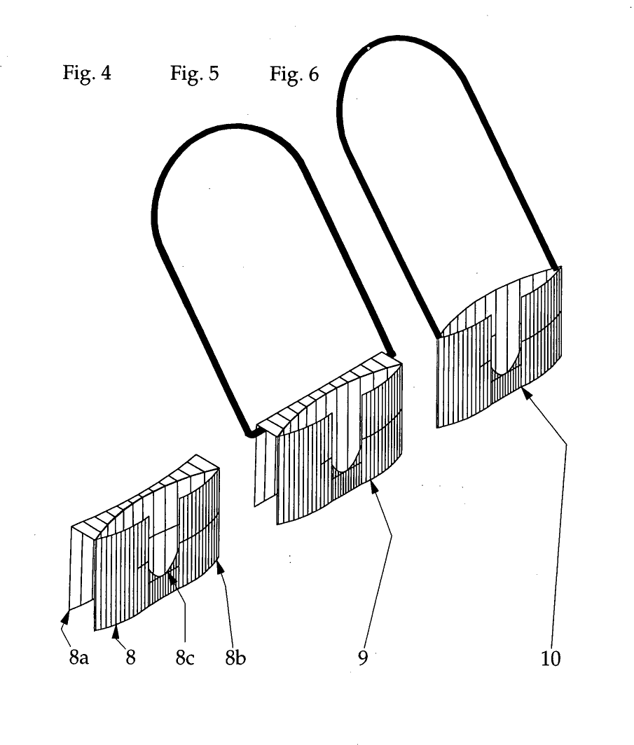

FIG. 4 of said U.S. Patent shows a directly inappropriate arrangement with a hook fastener—a collector of contaminations in itself—attached to a belt, at least if said belt embrace the outer garments of the medical staff.

If said last mentioned device is applied to a belt or to a waistband located under a protective coat, some of the most important aspects of the present invention are hereby obsolete, namely to be clearly and apparently visible—creating a reminder effect—to be ready for direct and immediate use without further action—rapid in use—to immediately distribute the quantity desired—providing an extremely short time lap for letting out the amount desired—and without jeopardizing potential stress fractures in the manipulating hand, when used frequently—hereby avoiding strain potentially impeding usage.

Said known device comprises a pump mechanism manipulated by an upward protruding part 14′. Further, said device comprises a small volume of liquid, having a physical size, an appearance and attaching means confusingly similar to corresponding features of usually used cellular telephone.

A large number of pumping manipulations by the hand on this known device during a working pass substantially increase the risk of developing known problems such as pain and more or less permanent damages at repeatedly stressed motion of fine motor ability of the muscles of a hand—corresponding to, for instance, the risk of develop repetitive strain injuries (RSI), when using computers for a longer period of time, RSI and similar disorders when working as cashier at supermarkets, the risk of getting tennis elbow and so on.

It is well documented that a number of contagions primarily or very often are disseminated by contacts of hands between persons more or less sensitive to infections, which persons will or may be infected by infectious diseases.

Soaking of the hands by alcohol and by other disinfectant solutions or gels will kill or inactive most contagions and inhibit further dissemination of such contagions.

Disinfectant solutions are therefore since long ago in use in the health care sector. The medical staff should soak their hands with a disinfectant solution between every contact with patients—also, of course, including contact between colleagues, persons, objects, surfaces and so on—regardless whether the hands have been covered by gloves or not. To make such actions possible, there are containers comprising disinfectant solutions arranged, normally close to basins for cleaning hands in health care premises. Such devices are stationary arranged and are available in a limited number of locations in the working environment.

In real life, said known solution work unsatisfactory, which has been noted by, among others, the health care sector and by the Institute for Infectious Disease Control (SMI) in Sweden as well as in the rest of the world.

It is in reality more or less impossible for medical staff to follow the basic rules of hygiene like disinfection of hands between every contact with patients. The reason for this is primarily that the hand decinfection devices are not located in such way that they are quickly accessible and simple to use when mostly needed.

The difficulties to disinfect are also due to a high working pace within the health care sector and the large number of patients. The contacts with such patients occur in different locations worsening the problem.

Shorter times of care, quicker through flow of patients, more and also elderly persons sensitive to infections become infected and carrier of the infections and passing them on.

The pressure of antibiotics on microbes and imports and/or the exchanges of microbes and resistant bacteria between persons and objects from different countries have increased.

The number of infectious sensitive patients, surviving longer period of times, having decreased immunity systems against infections, does increase. The need of limiting the passing on effect of infections becomes even more important.

An illustrative example of the necessity to recurringly and repeatedly be able to disinfect is the transfer of infections due to contact between objects—for instance working tools like personal beepers, pencils and so on. Such objects have been shown as being contaminated with infectious matter, are regularly and repeatedly used a number of times during a day by doctors and by other medical staff, as disclosed by a recently published study of U.S. hospitals.

Said study showed that the presence of staphylococcus on the beepers of the doctors was very common and comprised in a couple of cases antibiotic resistant staphylococcus.

A corresponding case is impossible to solve if the doctor, for instance, disinfect the beeper, as it will be quickly contaminated again.

Responding to a beeper signal normally happens under stressed conditions. Disinfection after contact with contaminated objects and before repeated patient contact must therefore be done properly in reality.

Contacts with pencils and other objects, which may be contaminated, create corresponding problems.

In for instance Huddinge University Hospital, a zero tolerance policy has been introduced concerning use of rings on fingers of hands as well as wristwatches and other objects increasing the risk of transfer of contaminations. Also introduced are new strict rules concerning hygiene and disinfection of hands and of other surfaces of contact.

The optimal solution would be a constantly sterilized environment and hygiene of the hands like the ones present in a surgical operating theatre, something rarely ever reached.

Even in other situations, for instance, in certain industrial environments, in laboratories, in massage institutes, in customs, in police work, among transportation personnel, among kindergarten personnel, among people working with food and so on, there is the corresponding problem with contamination and transfer of infectious matters by contact via hands and via handshakes.

The above mentioned problems and disadvantages must in other words be solved in a different and more adequate way than so far and the solution according to the present invention is based on the insight that people with frequent and predictable contacts with infectious or pollutive matters must protect themselves and others after contact with potential infectious or pollutive matters by instantly sanitising or disinfection independent of factual location at present. The same responsibilities exist, of course, for potential carriers of contaminations and for infection sensitive persons, namely to perform the required, or preventive, instant sanitising action.

Another problem intended to be solved by the present invention is to reduce the amount of unproductive time and provide the time space required for decontamination.

The problems and drawbacks as specified above in the preamble of the present specification have been solved in accordance with the present invention in that hand sanitising or disinfection can be performed instantly on the factual location of the person before or/and after contact with potentially contaminated or polluted objects, for example, beepers, or with persons carrying infections.

The solution according to the present invention comprises a mobile device wherein, as described in the preamble of the description, said valve comprises an openable closing valve, in that the device, in purpose of sanitation of, primarily, said hands of said person at a proper moment independent of factual location of said person, is arranged to be carried by said person in a manner such that said openable closing valve and said outlet are facing away from said person and are reachable with at least one hand of said person, in that said sanitary substance of said container is pressurized, exposed to or by gravitation, or in any other way influenced to, in a single motion and immediately, distribute desired and depending on manual action time of said openable closing valve amount of sanitary substance via said outlet, as soon as said openable closing valve is opened, and in that said container is designed to collapse essentially without letting in air to the inner of the container, when emptying said container.

Other aspects and details of the present invention are apparent from the appended claims and from the description. Below are disclosed some, non-limiting examples of implementation, disclosed by enclosed drawings, of which

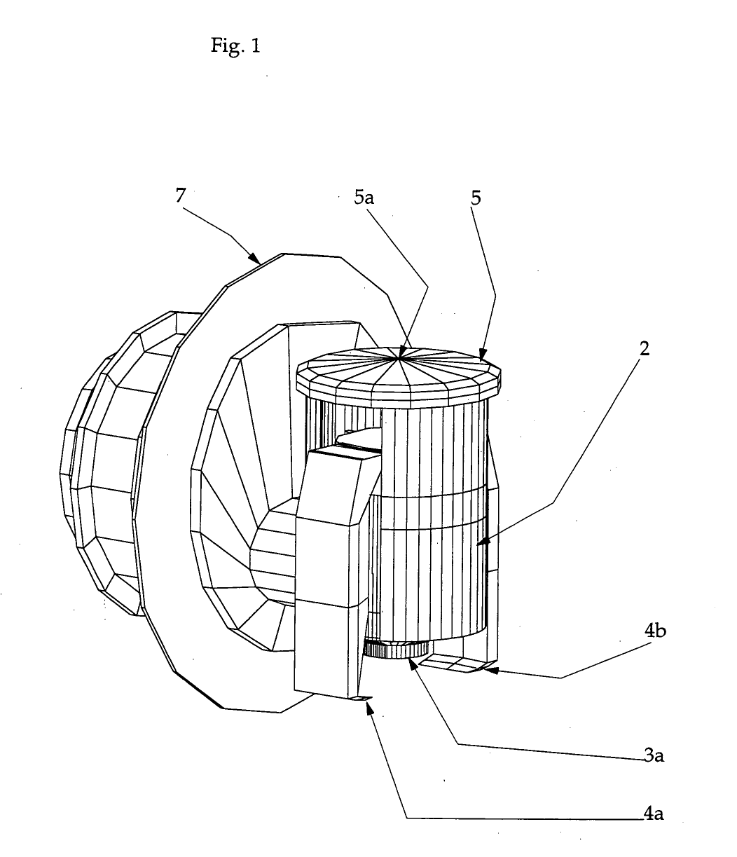

FIG. 1 in a perspective view is showing, solely as example, an openable closing valve with potential connecting means to a bag,

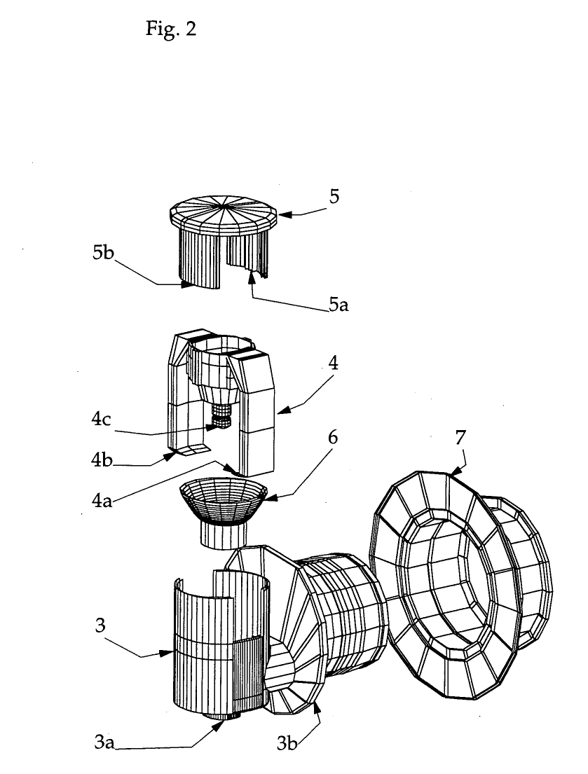

FIG. 2 in a perspective view, is also showing, essentially opposite to FIG. 1, parts of said closing valve,

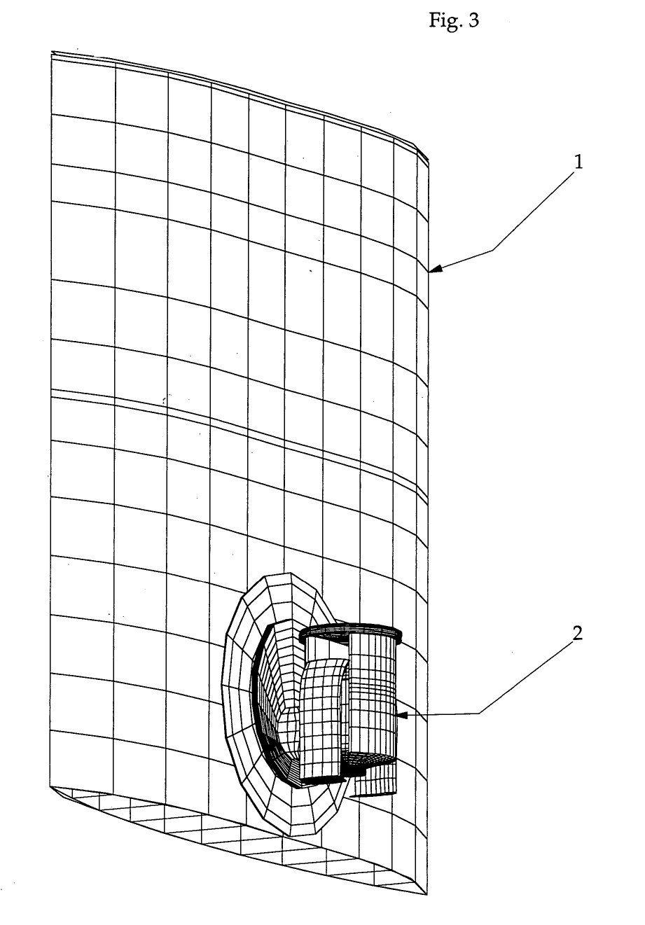

FIG. 3 in a perspective view is showing an according to the present invention appropriately designed bag comprising a valve according to FIGS. 1 and 2 and containing sanitary or disinfection substance,

FIGS. 4, 5 and 6, respectively, in perspective view are showing different holders enabling carrying and holding a bag with a valve according to FIG. 3 in position on a person intended to be carrying the bag with valve and

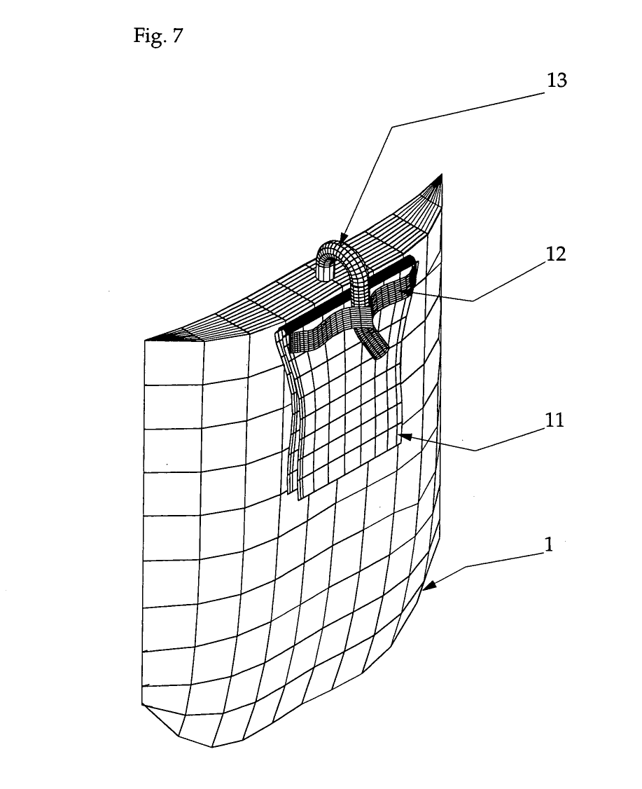

FIG. 7 in a perspective view is showing another kind of holder with a valve and a differently designed bag with, for instance, disinfection substance.

One embodiment of the present invention according to FIG. 3 comprises a packaging 1 made of a preferable metalized plastic film or foil, for instance made of polythene or any other suitable material, the bag is preferably made of a flexible or elastic and possible rebounding material, if required, which material is adapted to and supplied with, for this purpose adequate, gaseous, liquid, or semi liquid disinfectant, sterilizing and/or sanitising substances, for instance consisting of alcohol, mixed with a gel, 60% 2-Propanol, which normally is used in the health care sector, 70% Ethanol with or without additional disinfectant solutions, Chlorhexidine, or other known substances suitable for sanitary purposes.

The bag 1 is in this embodiment provided with an openable closing valve 2, disclosed as an example in FIGS. 1 and 2.

The bag 1 may, for instance, be adapted in size essentially to be carried all the time by a person and, for example, in a pocket, of an outer jacket, of a coat, of an outer cover garment or of a sailors jumper, which pocket in such cases previously has been provided with a opening similar in size to the valve 2 such that the valve 2 of the bag 1 protrude from the pocket and is facing away from the person who carries the device. As an explanatory implementation the size of the bag 2 is approximately 18×18 centimetre, (cm) and containing approximately 5 decilitres, (dl), preferably approximately 3 dl, and the valve 2 has a vertical height approximately 3 cm.

The content of the bag 1, comprised by a sanitary or disinfectant substance of an appropriate formula, may be supplied to the inner of the bag 1 in connection with the manufacturing of said bag 1, after manufacturing of said bag 1, for instance backwards through the valve 2, if said valve 2 is held opened while filling, or the bag 1 may optionally be provided with an openable and closable filling part not described in detail, as desired in each individual case. Below is it assumed that, for explanatory purposes, the content of the bag 1 and valve 2 are designed and used as a disposable article, wherein the bag 1 is designed to collapse gradually when being emptied of its content without letting in the surrounding air.

As a first alternative example, the bag 1 in preferably the upper part thereof can be provided with a band, not shown in the drawings, which band is to be carried by the person in question diagonal over one shoulder such that the bag 1 is located on the opposite side of the body of said person, for instance, carried out if said band or said carrying string is attached in two separate locations relative to the upper part of the bag with the aid of adapted attaching means, for instance of the kind that pinch the bag in place between its consisting parts, marketed under the trade mark HOLDON.

Attached to the bag 1 or the packaging is said openable closing valve 2 or any other, suitable kind of outlet device. Said device may or may not be designed with a pumping action as well. A basic condition is that the valve 2 is easily reachable without interference by the person carrying the bag 1 with said valve 2 protruding from the outer pocket, in which the bag 1 in the first case according to above is located, with at least his one hand enabling a distribution of a desired amount of sterilizing, disinfectant or sanitising substance or solution from the inner of the bag 1.

The amount let out is smeared out and distributed over the hands or other parts needed sanitising by means of said amount of the content of the bag 1.

In its most basic form, the openable closing valve 2 is located in the lower part of the bag 1 and the substance in the bag or container 1 is exposed to gravitation—or/and is exposed to pressure created by the arm or hand to compress the bag—and through such actions increase pressure in the bag 1 such that the liquid is let out more easily—to letting out desired amount when one of the hands of the carrier of the device grip over the lid 5 of the valve 2 with his/her palm opening the closing valve 2 while sensing, for instance, the slightly heightened centre of the lid 5a, making sure that the lid 5 is essentially located in the centre of the palm and in that the distance to the opening wings 4a, 4b of the valve 2, which wings are preferably independently separated and are directed inwards against the centre of the valve 2 and can also be arranged slightly at an angle corresponding to, for example, the curvation of the hand, is chosen to be approximately 2-5 cm, preferably approximately 3 cm. Said distance corresponds mainly to the distance between the centre of the palm and the tip of the fingers when bent, for a hand normally sized.

Between the opening mechanism 4 of the valve 2, essentially half way between its opening wings 4a, 4b, there is located an outlet 3a from a valve seat 3, which outlet 3a also is located in a vertical direction such that it opens up above the opening wings 4a, 4b, even if said opening wings 4a, 4b, are fully affected—pulled in—by said hand. Hereby is secured in an easy way of, by means of the grip of one hand having the palm of said hand against the lid 5 and the fingers against the opening wings 4a, 4b, opening of the carrier 4c of the opening mechanism and by that bringing a flexible sealing 6 in a upwards direction, see especially FIG. 2, in such manner that the valve seat 3 opens up in relation to a sealing ring 7, which is glued or in any other suitable way attached to the bag 1 and which opens up to the inner of the bag 1. The flexible sealing 6 is limited in its vertical movement by the lower flange surfaces 5a, 5b, of the lid 5 and the flexible sealing 6 includes a spring as well for the return stroke of the opening wings 4a, 4b, as soon as said grip of said hand pulling in is removed. Hereby is ensured that the let out amount of substance from inside the bag 1 is distributed on the inside of the same hand which grips the valve 2, if desired.

The outlet 3a aims the let out amount of substance from the bag 1 directed primarily downwards but may be directed in different directions, which may be essentially between horizontal and vertical directions having the purpose of making sure that the substance without impediment is ending up in the hand aimed at and in question.

Other kinds of valves are of course possible and reasonable to use in this context, for instance such closing valves which may be opened without contact, which valves have a pumping action built in and so on.

Another alternative is that a packaging 8, 9, 10, see FIGS. 4-6, for a bag 1 having a valve 2 can be suitably attached to the outside of a garment. This packaging 8 can be attached by means of a simple suspension, for instance a stiff board 8a adapted to fit into a pocket, which board is to be slid into said existing outer pocket of the garment while the rest 8b of the packaging 8 is located outside of said pocket and a container 1 with a valve 2 is then pushed down into the remaining part of the packaging 8b with the valve 2 located in and held in place by a slot 8c within the remaining part 8b.

Example of other ways of attaching either the container 1 or a packaging comprising the container 1 may include hooks, Velcros, straps or magnetic or any other suitable kind of attaching means.

In FIGS. 5 and 6, other examples of holders 9,10 are disclosed which are to be carried by the person in question with the aid of shoulder straps.

In FIG. 7, another example of implementation of the present invention is shown, which example is shaped to fit in a chest pocket of an outer garment or can be hooked onto a belt or the lining of trousers or skirts. The container 1 can in relevant cases be individually adapted to the chest pocket and/or to the chest of the person carrying it and be attached by clips 11, which grab, hold and keep the container 1 in place, for example, in the chest pocket. The container 1 is further provided with a flexible tube 13 located inside said container 1 and made out of, for instance, silicone, which tube is deviced to by means of, for example, an applied pressure within the container 1, created by, for example, inert gas, mechanical or manual applied pressure letting out, for instance, the disinfectant substance from the inner of the container 1 as long as a closing valve 12 is held opened. Due to relocation sideways of the tube 13, said tube 13 is squeezed against closing valve 12 enough to stop the flow of said substance.

In another embodiment, the bag with the sanitising substance can instead be designed as a disposable article without closing valve and is deviced to quickly and easily be hanged in a holder which is attached to the garment of a person via, for instance, snap fastener, whereupon a closing valve applied to the holder manually is arranged to penetrate the walls of the container into the sanitising substance in an airtight manner and, thereafter, when manipulating the closing valve automatically letting out said sanitising substance through an outlet permanently arranged on the holder.

Other embodiments of the present invention are of course possible within the scope of the appended claims. The contents of the drawings and claims are regarded as being part of the description as well.

1. A device enabling sanitation of the hands of at least one person and including a container (1) comprising a sanitary substance and a valve (2, 12) making possible repeatedly distributing via an outlet from said container (3) of the amount of said sanitary substance desired,
wherein: said valve comprises an openable closing valve (2, 12), in that the device, in purpose of sanitation of, primarily, said hands of said person at a proper moment independent of factual location of said person, is arranged to be carried by said person in a manner such that said openable closing valve (2) and said outlet (3a) are facing away from said person and are reachable with at least one hand of said person, in that said sanitary substance of said container (1) is pressurized, exposed to or by gravitation, or in any other way influenced to, in a single motion and immediately, distribute desired and depending on manual action time of said openable closing valve (2) amount of sanitary substance via said outlet (3a), as soon as said openable closing valve (2) is opened, and in that said container (1) is designed to collapse essentially without letting in air to the inner of the container (1), when emptying said container.

2. The device according to claim 1,
wherein: said openable closing valve (2) is openable in one direction while executing a counteraction in an essentially opposite direction.

3. The device according to claim 1
wherein: said openable closing valve (2) is openable in a vertical direction essentially from below and upwards and preferably when executing a counteraction essentially from up and downwards.

4. The device according to claim 1,
wherein: said outlet (3a) at least essentially in a horizontal direction discharges at a distance from the container (1).

5. The device according to claim 2,
wherein: said outlet (3a) is located in such a manner relatively to an opening mechanism (5, 4a, 4b) of said valve (2) that the distribution of said sanitary substance is provided in the same hand as used for opening said valve (2).

6. The device according to claim 1,
wherein: said valve (2) and said outlet (3) are designed as an undivided unit, located in a lower part of said container (1) having the outlet (3a) essentially directed downwards.

7. The device according to claim 1,
wherein: it includes a container (1) having preferable flexible walls, which container (1) is essentially sealed airtightly or is in relevant cases airtightly locked after supplying said sanitary substance.

8. The device according to claim 1,
wherein: it is designed (8, 9, 10, 11) to be applied relatively to the outer garment of said person and preferable distal thereof.

9. The device according to claim 1
wherein: it is designed (8, 9, 10, 11) to be detachable applied relatively to an outer garment respectively to said outer garment of said person and preferably applied distal thereof.

10. The device according to claim 2, wherein: said openable closing valve (2) is openable in a vertical direction essentially from below and upwards and preferably when executing a counteraction essentially from up and downwards.

11. The device according to claim 2, wherein: said outlet (3a) at least essentially in a horizontal direction discharges at a distance from the container (1).

12. The device according to claim 3, wherein: said outlet (3a) at least essentially in a horizontal direction discharges at a distance from the container (1).

13. The device according to claim 3, wherein: said outlet (3a) is located in such a manner relatively to an opening mechanism (5, 4a, 4b) of said valve (2) that the distribution of said sanitary substance is provided in the same hand as used for opening said valve (2).

14. The device according to claim 4, wherein: said outlet (3a) is located in such a manner relatively to an opening mechanism (5, 4a, 4b) of said valve (2) that the distribution of said sanitary substance is provided in the same hand as used for opening said valve (2).

15. The device according to claim 2, wherein: said valve (2) and said outlet (3) are designed as an undivided unit, located in a lower part of said container (1) having the outlet (3a) essentially directed downwards.

16. The device according to claim 3, wherein: said valve (2) and said outlet (3) are designed as an undivided unit, located in a lower part of said container (1) having the outlet (3a) essentially directed downwards.

17. The device according to claim 4, wherein: said valve (2) and said outlet (3) are designed as an undivided unit, located in a lower part of said container (1) having the outlet (3a) essentially directed downwards.

18. The device according to claim 5, wherein: said valve (2) and said outlet (3) are designed as an undivided unit, located in a lower part of said container (1) having the outlet (3a) essentially directed downwards.
